(19) United States
(12) Patent Application Publication
(10) Pub. No.: US 2015/0345212 A1
(43) Pub. Date: Dec. 3, 2015

(54) APPARATUS FOR COVERING A VIEW OPENING

(71) Applicant: HTP HIGH TECH PLASTICS GMBH, Fohnsdorf (AT)

(72) Inventor: André WIECZOREK, Leoben (AT)

(73) Assignee: HTP HIGH TECH PLASTICS GMBH, Fohnsdorf (AT)

(21) Appl. No.: 14/762,257

(22) PCT Filed: Jan. 22, 2014
(86) PCT No.: PCT/EP2014/051249

§ 371 Date: Jul. 21, 2015

(30) Foreign Application Priority Data
Jan. 22, 2013 (AT) A 40/2013

(51) Int. Cl. E06B 9/264; E06B 9/24; E06B 9/58; E06B 9/40

(52) U.S. Cl. CPC E06B 9/264; E06B 9/40; E06B 9/24; E06B 9/58; E06B 2009/2643

(57) ABSTRACT

An apparatus for the dimmed covering of a view opening (2) in a cladding of a passenger compartment that is subjected to shocks or vibrations, wherein the view opening (2) is formed by at least two transparent panes which are arranged parallel to each other in the cladding and between which a dimming cover element is arranged that can be moved via an actuating device with an operating element arranged in the exterior space of the panes between a position which releases the view opening (2) and a position covering the view opening (2). It is proposed in accordance with the invention that the cover element is formed as a cover sheet (4) which can be unwound from a receiving roll (3) and of which the free end of the unwound section can be moved so as to traverse the view opening (2), and a revolving traction element (6) is provided, which is formed on the one hand as a rotary drive for the receiving roll (3) and is connected on the other hand to the free end of the cover sheet (4), wherein a tensioning element is provided for the cover sheet (4) and the unwound section of the cover sheet (4), in its lateral regions extending perpendicularly to the receiving roll (3), rests in a light-impermeable manner with at least one of its surfaces on a contact surface (13) which is stationary relative to the cladding.

The invention relates to an apparatus for the dimmed covering of a view opening in a cladding of a passenger compartment that is subjected to shocks or vibrations, wherein the view opening is formed by at least two transparent panes which are arranged parallel to each other and between which a dimming cover element is arranged that can be moved via an actuating device with an operating element arranged in the exterior space of the panes between a position which releases the view opening and a position covering the view opening, according to the preamble of claim 1.

The cladding of a passenger compartment that is subjected to shocks or vibrations concerns an aircraft fuselage or a boat hull, and the view opening concerns a window whose at least two panes are made of a highly transparent or transparent material such as glass or plastic. In order to dim the passenger compartment, a covering is provided which is arranged between the at least two panes and which can be moved from the passenger compartment via an operating element between a position releasing the view opening and a position covering the view opening. It is known to arrange the cover element in form of a bellows-like folding, wherein the individual folding layers sit close to each other in the position of the cover element releasing the view opening, so that the cover element is provided with maximum shortening, and the individual folding layers are spaced from each other in the position of the cover element covering the view opening, so that the cover element extends over the view opening. The free end of the cover element is drawn by actuation of the operating element to a position covering the view opening and pushed to a position releasing the view opening, wherein the lateral edges of the view element are guided between two lateral frame elements.

Such a known embodiment shows a number of disadvantages. A first disadvantage relates to the transparency of such a cover. Although the folded cover element rests on lateral frame elements with its side edges, gap-like cavities are formed between the lateral frame and the cover element especially during shocks or vibrations of the passenger compartment, through which scattered light can reach the passenger compartment. Additional transparency is provided by the cover element per se. The cover element is mostly made of a fabric which is provided with a reinforcing and light-impermeable coating, e.g. a metal coating. As a result of the subsequent folding process which is repeated during operation, the coating can especially break in the bending edges of the folding layers and cause impairment to the light impermeability in the folding edges.

A further disadvantage is provided by material abrasion by the cover element, since the folded cover element rests with its lateral edges on lateral frame elements and is mostly made of a fabric. In practice, the fabric cannot be cut precisely along the yarns extending in the longitudinal direction, as a result of which individual fibres are severed in the cutting direction. Depending on the quality of the cutting and the quality of the fabric, there are laterally protruding individual fibres which are no longer embedded in the fabric composite at the cutting edges, which fibres are worn off on the lateral frame elements by the continuous sliding during actuation and subsequently accumulate between the panes and cause accumulations of dirt. Cleaning of the interior space of the view opening is only possible with much effort, or the view opening is replaced by a new view opening which causes respective costs.

A further disadvantage also relates to the smooth running of the actuating device of the cover element. The cover element is mostly arranged as a slide whose horizontal movement for example is converted via a transforming gear into a vertical movement of the cover element. Since the horizontal path of movement of the slide is limited and mostly smaller than the necessary part of movement of the cover element, a transforming gear must usually be provided which converts the horizontal path of movement of the slide into greater vertical lift. Such a conversion requires the input of force which is necessary for actuating the cover element. This input of force is also increased by frictional forces between the lateral edges of the cover element and the lateral frame, and also by an installation in the curved claddings and their view openings. Notice must be taken that a minimum required input of force for actuating the cover element is also necessary in the case of self-inhibiting folded embodiments, because otherwise the cover element would no longer remain in its position releasing the view opening as a result of shocks and vibrations.

Furthermore, folded cover elements which are guided between two lateral frame elements also produce an undesirable generation of noise in the case of vibrations and shocks by rattling of the cover element and impacts against the panes or the lateral frame elements. Furthermore, the cover element must be held in a secure and light-impermeable manner even in intermediate positions between the completely open view opening and the completely closed view opening.

There may further be a desire for enlarging the view opening and for an electrical actuating device for the cover element. The aforementioned disadvantages will be all the more severe the larger the view opening is arranged, so that the overall size of the view opening is limited. Electrical actuating devices on the other hand require extra space, which thus directly counteracts the desire for an enlargement of the view opening. Generally desired are smoothly running systems with an inhibiting system which enables a purposeful setting of the inhibiting force. Such systems would allow higher design flexibility for dimming apparatuses. In particular, smoothly running systems in electromechanical actuating devices are advantageous. As a result, smaller electromechanical actuating systems can be installed, leading to a reduction in the weight of the entire system.

It is thus the object of the invention to avoid these disadvantages and to provide a cover apparatus which on the one hand offers the highest possible level of light impermeability and ease of operation on the one hand, and a low tendency towards abrasion and contamination as well as minimal noise generation on the other hand. These advantageous properties shall also be maintained under shocks and vibrations, wherein every position shall be adjustable between the end positions and the position shall also be maintained in the case of shocks and vibrations.

These objects are achieved by the features of claim 1. Claim 1 relates to an apparatus for the dimmed covering of a view opening in a cladding of a passenger compartment that is subjected to shocks or vibrations, wherein the view opening is formed by at least two transparent panes which are arranged parallel to each other in the cladding and between which a dimming cover element is arranged that can be moved via an actuating device with an operating element arranged in the exterior space of the panes between a position which releases the view opening and a position covering the view opening. It is proposed in accordance with the invention that the cover element is formed as a cover sheet which can be unwound from a receiving roll and of which the free end of the unwound section can be moved so as to traverse view opening, and the actuating device comprises a traction mechanism drive for the receiving roll with a revolving traction element, which is placed in a revolving motion by actuation of the operating element and is connected to the free end of the unwound section of the cover sheet, wherein a tensioning element is provided for the unwound section of the cover sheet, and the unwound section of the cover sheet rests in a light-impermeable manner at least over the extension of the view opening in its lateral regions extending perpendicularly to the receiving roll with at least one of its surfaces on a surface which is stationary relative to the cladding. In accordance with the invention, an unwindable cover sheet is thus provided, wherein the unwinding or winding up of the cover sheet is provided on the one hand by rotation of the receiving roll, but also by the traction effect on the free end of the cover sheet. As a result of the manipulation of the cover sheet by the traction element on both sides, controlled winding up and unwinding of the cover sheet under tension and respective guidance of the free end is ensured, and thus a reproducible winding diameter. Since the available overall space for the receiving roll in particular is limited, the winding must occur in a reliable and tight way because otherwise jamming of the cover element may occur in the case of an incomplete winding. Such jamming or rubbing of the cover element would also lead to increased abrasion with the aforementioned disadvantages. That is why the use of a torsion spring or the like was omitted as a rotary drive for the receiving roll and a fraction element is used instead which synchronises the movement of the receiving roll with the free end of the cover sheet. Since a constant rotary angle of the receiving roll leads to a decreased unwinding length with progressing unwinding of the cover sheet, a tensioning element for the unwound section of the cover sheet is provided in accordance with the invention in order to maintain constant tension for the cover sheet. As a result, the cover element is tensioned in a defined manner in each position, thus preventing impermissible “fluttering” in operation especially by shocks or vibrations.

It is further provided in accordance with the invention that the unwound section of the cover sheet, in its lateral regions extending perpendicularly to the receiving roll, rests in a light-impermeable manner at least over the extension of the view opening with at least one of its surfaces on a contact surface which is stationary relative to the cladding. The cover sheet in accordance with the invention does not impinge with its lateral edges on lateral frame elements, but rests with at least one of its surfaces in a light-impermeable manner on a contact surface. This measure reduces abrasion of the cover element especially when formed as a coated fabric, because no exposed fibre ends occur in the surface which would be subject to abrasion, and the mostly coated surface is more resistant to abrasion than the unprotected lateral edge. As a result of the contact of the cover sheet on a contact surface, a light-impermeable connection between the contact surface which is arranged in a stationary manner relative to the cladding and the cover sheet which is slightly movable relative to the cladding is provided even in the case of vibrations and shocks because a precise mutual alignment is no longer relevant for light impermeability. As a result, scattered light into the passenger compartment is thus also reliably prevented in the case of vibrations and shocks, and approximate light impermeability is achieved. Furthermore, the sliding on the contact surface leads to less noise generation than the impacts on lateral frame elements, so that the embodiment in accordance with the invention is nearly free from noise both during actuation of the cover element and also in the case of vibrations and shocks. Since the cover sheet need not be subjected to any subsequent folding steps, impairments in the light impermeability caused by production can also be avoided.

Furthermore, the distance between the panes between which the cover element is arranged can also be selected to be smaller because no folded cover element needs to be accommodated and in particular no folding assembly in the position in which the cover element releases the view opening.

The tensioning element can be arranged as a tension rod for example, which is arranged axially parallel to the receiving roll via a suspension which is arranged elastically in the perpendicular direction relative to the tension rod, and the unwound section of the cover sheet is guided via the tension rod. The tension rod can also be arranged as a roll. The elastic suspension can also be realised by means of a spring.

A further embodiment of the tensioning element provides that the receiving roll is arranged in a frictionally engaged manner in relation to a driven roll of the traction element and the tensioning element is formed as an elastic pressing apparatus of the receiving roll against the driven roll which ensures that the frictional engagement. The receiving roll is thus placed in a revolving motion by a frictionally engaged connection of the driven roll of the tensioning element. The unwound section of the cover sheet is tensioned by the frictional engagement. The pressing apparatus can be arranged as a spring for example which connects the roller shafts of the receiving roll and the driven roll to each other and presses the receiving roll against the driven roll, so that constant frictional engagement is ensured.

In a further embodiment, the tensioning element can also be arranged as an elastic element which is connected with its first free end to the free end of the cover sheet and with a second end to the tensioning element. The elastic element can be arranged as a spring.

It is proposed with respect to the actuating device that it comprises a transmission gear in addition to the traction element, which connects the operating element with the revolving traction element, wherein the transmission gear comprises a drive gear for the tensioning element. The traction element is arranged as a revolving belt for example, which is deflected on the drive gear on the one hand and on the receiving roll on the other hand. This arrangement is very simple and compact from a mechanical standpoint, wherein the operating element can also concern an electrical element such as a pushbutton or a switch.

As already mentioned, the available space is very constricted in practice. If the tensioning element is arranged as an elastic element which is connected with a first end to the free end of the cover sheet and with a second end to the traction element, it represents an additional component which needs to be housed, especially in the position in which the cover sheet covers the view opening. In this position, the free end of the cover sheet and thus usually also the tensioning element are situated close to the drive gear because the drive gear and the receiving roll are usually arranged at opposite ends of the view opening. That is why it is proposed that a support is provided for the tensioning element, which is fixed to the traction element between the receiving roll and the drive gear, wherein the support comprises an extension extending in the direction of the drive gear along the outer surface of the tensioning element facing away from the drive gear, and the tensioning element is fixed at the one end to the extension and at the other end to the free end of the cover sheet. The support can thus be moved closer to the drive gear.

The contact surface for the cover sheet may merely be provided on one of the two surfaces of the cover sheet. This arrangement is especially sufficient in the case of curved claddings because the cover sheet ensures reliable contact in this case with its deadweight if the contact surface is arranged on the concave side of the cladding. It can also be provided that the unwound section of the cover sheet, in its lateral regions extending perpendicularly to the receiving roll, rests in a light-impermeable manner with its two surfaces on a contact surface. A light-impermeable contact can also be ensured in this manner even in the case flat embodiments of the cladding. Furthermore, the cover sheet is laterally clamped in this case on both sides, thus reducing the noise generation and improving light impermeability.

In order to reduce abrasion, it can further be provided that the unwound section of the cover sheet rests in its lateral regions extending perpendicularly to the receiving roll on the contact surface via flexible elements such as brush strips or felt strips or the like for example. The tensioning element can be arranged as a belt for example.

The invention will be explained below in closer detail by reference to embodiments shown in the enclosed drawings, wherein:

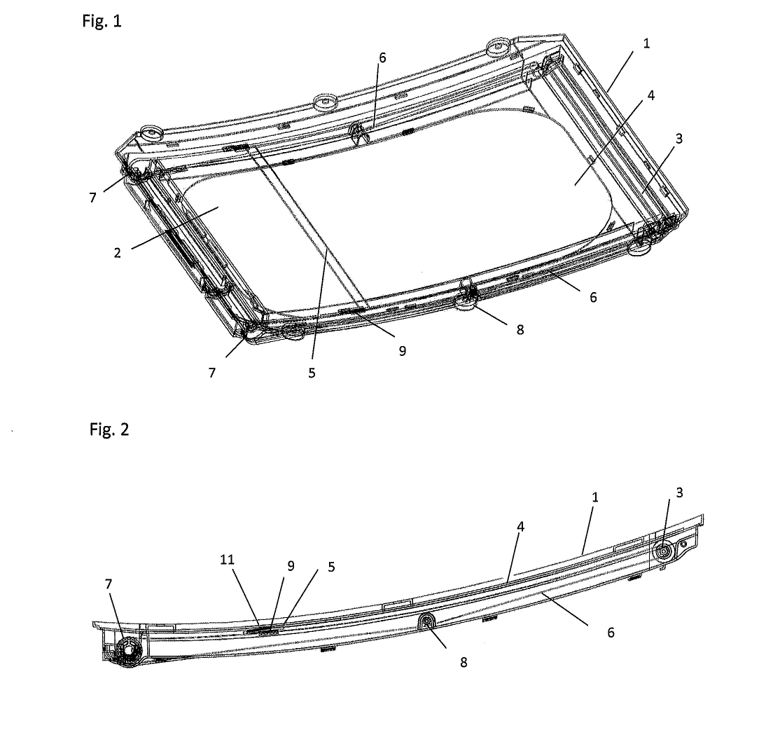

FIG. 1 shows a cladding element with a view opening in a perspective view;

FIG. 2 shows a lateral view of the cladding element according to FIG. 1;

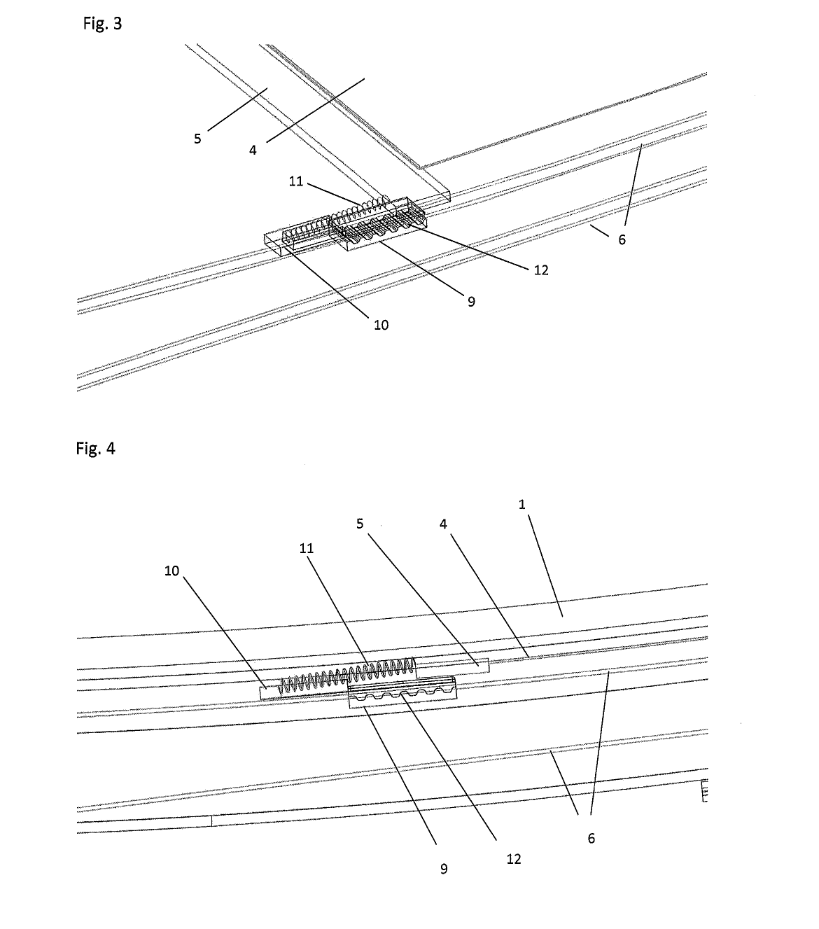

FIG. 3 shows a detailed view of the support for a tensioning element according to a first embodiment in a perspective view;

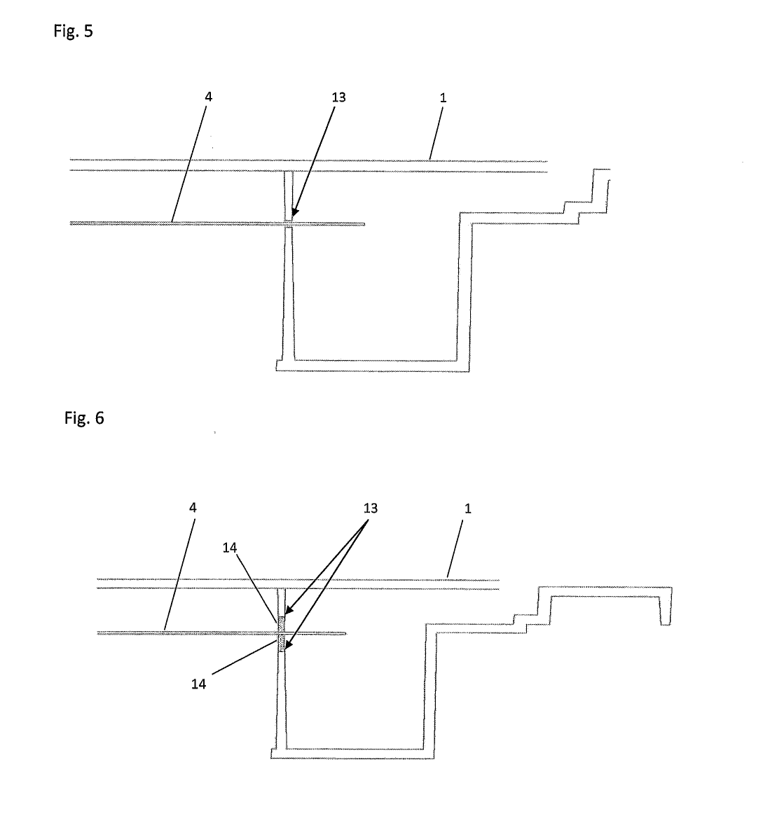

FIG. 4 shows a lateral view of the support of the tensioning element according to FIG. 3;

FIG. 5 shows a first embodiment of the contact surface;

FIG. 6 shows a further embodiment of the contact surface with brush strip;

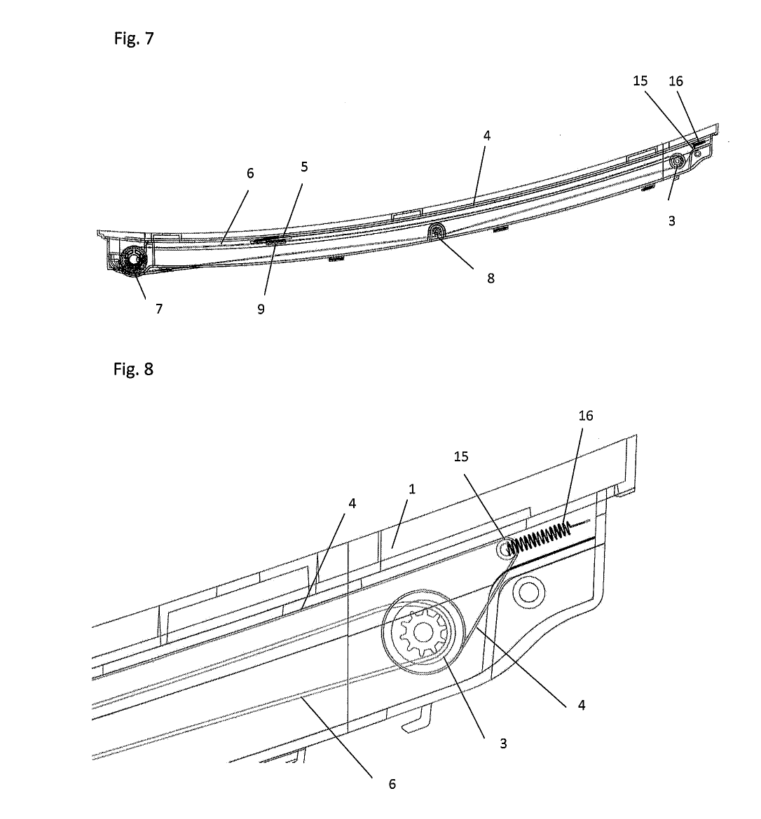

FIG. 7 shows a lateral view of the cladding element according to FIG. 1 with a further embodiment of the tensioning element;

FIG. 8 shows a detailed view of the tensioning element according to FIG. 7, and

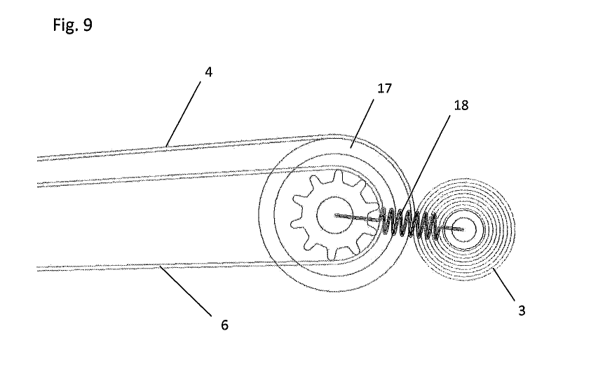

FIG. 9 shows a further embodiment of the tensioning element.

FIG. 1 shows a cladding element 1 with a view opening 2, wherein the view opening 2 comprises at least two panes which are arranged in parallel at a distance from each other. A receiving roll 3 is rotatably fixed to the cladding element 1 on one side of the view opening 2, which receiving roll extends at least over the width of the view opening 2 and on which a cover sheet 4 is wound up. The unwound section of the cover sheet 4 has a free end which is provided with a termination strip 5, wherein the free end of the unwound section can be moved to traverse the view opening 2. A revolving traction element 6 is arranged on both sides to the side of the view opening 2, which traction element is a part of the traction mechanism drive for the receiving roll 3 and extends substantially perpendicularly to the receiving roll 3. The traction mechanism drive can be arranged as a belt or chain drive. The traction element 6 is a belt in the former case, e.g. a toothed belt. In the embodiment of FIG. 1, the revolving traction element 6 is deflected on the receiving roll 3 on the one hand and on a drive gear 7 on the other hand, wherein the drive gear 7 and the receiving roll 3 are arranged on opposite sides of the view opening 2. In the case of curved claddings, one or several deflection rollers 8 can additionally be provided for the traction element 6. The cover sheet 4 is guided between the at least two panes and is placed in revolving motion via an operating element and optionally a transmission gear. The other components such as the receiving roll 3 or traction element 6 can also be arranged outside of the panes. FIG. 2 shows a lateral view of the cladding element according to FIG. 1.

A first embodiment of the tensioning element will be explained at first by reference to FIGS. 1 to 4, in which the tensioning element is arranged as an elastic element 11 which is connected with a first end to the free end of the cover sheet 4 and with a second end via a support 9 to the traction element 6. The support 9 is arranged on the tractive strand of the traction element 6. If the drive gear 7 is placed in revolving motion via the operating element and optionally a transmission gear, the support 9 is thus also moved, which is fixed to the traction element 6. The configuration of the support 9 is explained by reference to FIGS. 3 and 4. In accordance with the illustrated embodiment, the support 9 comprises an extension 10 which extends in the direction of the drive gear 7 on the outer surface of the traction element 6 which faces away from the drive gear 7. The elastic element 11 is fixed to the extension 10 of the support 9, which elastic element is arranged in the illustrated embodiment as a spring. The elastic element 11 is fixed at the other end at the termination strip 5 to the free end of the cover sheet 4. The support 9 per se can be fixed to the traction element 6 by means of a toothing 12, e.g. it can be tightly clamped thereon. The traction element 6 can be arranged for this purpose as a belt with a respective toothing. The toothing of the traction element 6 also ensures slippage-free drive by the drive gear 7 and the receiving roll 3.

Possible embodiments of the contact surfaces 13 for the cover sheet 4 are explained by reference to FIGS. 5 and 6. As was already mentioned above, the unwound section of the cover sheet 4 rests in a light-impermeable manner at least over the extension of the view opening 2 in its lateral regions extending perpendicularly to the receiving roll 3 with at least one of its surfaces on a contact surface 13 which is stationary relative to the cladding. Contact on both sides is shown in FIG. 5, in which the cover sheet 4 rests with both surfaces on contact surfaces 13 of the cladding element 1. This measure also ensures a light-impermeable connection between the contact surfaces 13 which are arranged in a stationary manner relative to the cladding and the cover sheet 4 which can be moved slightly relative to the cladding even in the case of vibrations and shocks, because no precise mutual alignment needs to be provided for the light impermeability. As a result, scattered light to the passenger compartment is reliably prevented even in the case of vibrations and shocks, and approximate light impermeability is achieved. Furthermore, the sliding on the contact surfaces 13 leads to less noise, both during actuation of the cover sheet 4 as well as during vibrations and shocks. The abrasion of the cover sheet 4 is additionally reduced in that the contact surfaces 13 are provided with flexible contact elements 14 such as brush strips, felt strips or the like, as shown in FIG. 6.

A further embodiment of the tensioning element is explained by reference to FIGS. 7 and 8, in which the tensioning element is formed as a tension rod 15, via which the unwound section of the cover sheet 4 is guided. The longitudinal axis of the tension rod 15 is arranged parallel to the rotational axis of the receiving roll 3. The suspension 16 of the tension rod 15 is formed in such a way that it is elastic perpendicularly to the tension rod 15, e.g. via a respective resilient bearing. As a result, the tension rod 15 can exert a tractive effect on the cover sheet 4 which tensions the cover sheet 4. The tension rod 15 can also be formed as a roll or the like. This embodiment can also be provided alternatively or in addition to the aforementioned embodiment of the tensioning element as an elastic element 11 between the termination strip 5 and the traction element 6. Even when a tension rod 15 is used as an additional or alternative tensioning element, the free end of the cover sheet 4 or its termination strip 5 is connected to the traction element 6, e.g. via a support 9.

FIG. 9 shows an embodiment of the tensioning element, in which the revolving traction means 6 does not drive the receiving roll 3 directly, but a driven roll 17 which is arranged in a frictionally engaged manner in relation to the receiving roll 3. The roll shafts of the driven roll 17 and the receiving roll 3 are arranged in parallel with respect to each other, wherein the surface of the driven roll 17 is in frictionally engaged contact with the surface of the receiving roll 3, i.e. the cover sheet 4 which is wound up on the receiving roll 3. A rotation of the driven roll 17 is thus converted via the frictionally engaged connection into a rotation of the receiving roll 3, wherein the cover sheet 4 is unwound. The rotational speed of the driven roll 17 is thus determined by the revolving speed of the traction element 6. The rotational speed of the receiving roll 3 on the other hand will increase with the progressing unwinding of the cover sheet 4. In order to ensure the tensioning of the cover sheet 4 during winding up in particular, the tensioning element is formed as an elastic pressing apparatus 18 which ensures the frictional engagement. The unwound section of the cover sheet 4 is tensioned by the frictional engagement. The pressing apparatus 18 can be arranged as a spring for example which connects the roll shafts of the receiving roll 3 and the driven roll 17 to each other, and presses the receiving roll 3 against the driven roll 17 so that constant frictional engagement is ensured.

The functionality of the illustrated covering apparatus is explained as follows. The drive gear 7 is placed in revolving motion by actuation of an operating element and optionally via a transmission gear, as a result of which the traction element 6 is also placed in revolving motion. The traction element 6 exerts a torque on the receiving roll 3 on the one hand and a tractive effect on the free end of the unwound section of the cover sheet 4, because the support 9 is also moved together with the traction element 6. The unwinding and winding up of the unwindable cover sheet 4 is thus achieved by the rotation of the receiving roll 3 on the one hand, and also by a synchronised tractive effect on the free end of the cover sheet 4. As a result of the manipulation of the cover sheet 4 on both sides, controlled winding up and unwinding of the cover sheet 4 under tension and respective guidance of the free end are ensured. Since however a constant rotational angle of the receiving roll 3 leads to a decrease in the unwinding length with progressing unwinding of the cover sheet 4, a tensioning element in form of an elastic connection is provided between the traction element 6 and the free end of the cover sheet 4 and/or a tension rod 15 in order to maintain constant tension in the cover sheet 4. In the position of the cover sheet 4 in which it releases the view opening, the tensioning element is tensioned differently than in the position of the cover sheet 4 in which it covers the view opening. The tensioning element 11 is pretensioned in such a way that it maintains a tension of the cover sheet 4 in each position of the cover sheet 4.

A covering apparatus is thus realised by means of the invention, which shows high light impermeability and smoothness in operation on the one hand, and a low tendency towards abrasion and soiling as well as minimal noise generation on the other hand. These advantageous properties are also maintained under shocks and vibrations.

1. An apparatus for the dimmed covering of a view opening (2) in a cladding of a passenger compartment that is subjected to shocks or vibrations, wherein the view opening (2) is formed by at least two transparent panes which are arranged parallel to each other in the cladding and between which a dimming cover element is arranged that can be moved via an actuating device with an operating element arranged in the exterior space of the panes between a position which releases the view opening (2) and a position covering the view opening (2), wherein the cover element is formed as a cover sheet (4) which can be unwound from a receiving roll (3) and of which the free end of the unwound section can be moved so as to traverse the view opening (2), and the actuating device comprises a traction mechanism drive for the receiving roll (3) with a revolving traction element (6), which is placed in revolving motion by actuation of the operating element and is connected to the free end of the unwound section of the cover sheet (4), wherein a tensioning element is provided for the unwound section of the cover sheet (4), and the unwound section of the cover sheet (4), in its lateral regions extending perpendicularly to the receiving roll (3), rests in a light-impermeable manner at least over the extension of the view opening (2) with at least one of its surfaces on a contact surface (13) which is stationary relative to the cladding.

2. The apparatus according to claim 1, wherein the tensioning element is formed as a tension rod (15) which is arranged in an axially parallel manner in relation to the receiving roll (3) via a suspension (16) which is arranged elastically in the perpendicular direction to the tension rod, and the unwound section of the cover sheet (4) is guided via the tension rod (15).

3. The apparatus according to claim 1, wherein the receiving roll (3) is arranged in a frictionally engaged manner in relation to a driven roll (17) of the traction element (6), and the tensioning element is formed as an elastic pressing apparatus (18) of the receiving roll (3) against the driven roll (17).

4. The apparatus according to claim 1, wherein the tensioning element is formed as an elastic element (11) which is connected with a first end to the free end of the cover sheet (4) and with a second end to the traction element (6).

5. The apparatus according to claim 1, wherein the actuating device further comprises a transmission gear which connects the operating element to the revolving traction element (6), wherein the transmission gear comprises a drive gear (7) for the traction element (6).

6. The apparatus according to claim 4, wherein the drive gear (7) and the receiving roll (3) are arranged on opposite sides of the view opening (2), and a support (9) is provided for the elastic element (11) which is fixed to the traction element (6) between the receiving roll (3) and the drive gear (7), wherein the support (9) comprises an extension (10) extending in the direction of the drive gear (7) along the outer surface of the traction element (6) facing away from the drive gear (7), and the elastic element (11) is fixed at the one end to the extension (10) and at the other end to the free end of the cover sheet (4).

7. The apparatus according to claim 1, wherein the unwound section of the cover sheet (4) rests in a light-impermeable manner with its two surfaces on a contact surface (13) in its lateral regions extending perpendicularly to the receiving roll (3).

8. The apparatus according to claim 1, wherein the unwound section (4), in its lateral regions extending perpendicularly to the receiving roll (3), rests via flexible contact elements (14) on the contact surface (13).

9. The apparatus according to claim 1, wherein the traction element (6) concerns a belt.
